(19) United States
(12) Patent Application Publication
(10) Pub. No.: US 2014/0089865 A1
(43) Pub. Date: Mar. 27, 2014

(54) HANDWRITING RECOGNITION SERVER

(71) Applicant: Co-operwrite Limited, Skelmersdale (GB)

(72) Inventors: Geoffrey Norman Walter GAY, Fairfield, IA (US); Billy MOON, Ennis (IE)

(73) Assignee: Co-operwrite Limited, Skelmersdale (GB)

(21) Appl. No.: 13/974,272

(22) Filed: Aug. 23, 2013

Related U.S. Application Data
(60) Provisional application No. 61/704,896, filed on Sep. 24, 2012.
(60) Provisional application No. 61/704,872, filed on Sep. 24, 2012.

(51) Int. Cl. G06F 3/0488

(52) U.S. Cl. CPC G06F 3/04883
USPC 715/863

(57) ABSTRACT

A gesture input application adapted for translating gesture input into font characters. A web application, such as a webpage, embedded with the gesture application is served over a network to one or more computing devices for local execution of the gesture put application by a web browsing software on the computing device. The web application includes rules for styling the webpage on the computing device and the source code for the gesture input application. The computing device executing the web application with the web browsing software receives from a user a gesture input and translates the gesture input into at least one standard font character as an input to the web application.

This application claims priority to Provisional Patent Application 61/704,896 filed Sep. 24, 2012 and Provisional Patent Application No. 61/704,892 filed Sep. 24, 2012 the entirety of which are incorporated by reference herein. This application is being filed concurrently with Nonprovisional patent application No. not yet assigned filed Aug. 23, 2013 titled METHOD AND SYSTEM FOR PROVIDING ANIMATED FONT FOR CHARACTER AND COMMAND INPUT TO A COMPUTER, by Gay et al, the entirety of which is incorporated by reference herein.

### BACKGROUND

This disclosure relates to a method and system for inputting hand-generated characters into a webpage, and more specifically, to a system and method for serving handwriting gesture input application to a computing device for local execution by the web browser of the computing device.

Text input to a small form-factor computer, especially a mobile device such as a smart-phone or personal digital assistant (PDA), equipped with a touch-sensitive screen has historically been via an on-screen keyboard. Because of the small form-factor of mobile devices, the screen is necessarily also small, for example, 50 min wide by 35 mm high, and the on-screen buttons for the letters of the alphabet are similarly small and require concentration and learned skill to accurately target with the fingers. In addition, the space occupied by the on-screen keyboard is not available for the display of other information, and thus the useful size of the display is further reduced.

To solve this problem, computer algorithms have been developed to allow finger movements over the touch-sensitive screen to input hand-written characters. Such handwriting recognition products take the complex finger movements made during hand-written input and analyze their shape and sequence to interpret the intended characters. These algorithms are complex, have inherent processing delays, are subject to errors of recognition and have not displaced on-screen keyboards in the majority of mobile devices.

### SUMMARY

A method is disclosed for providing on a server a gesture input application adapted for translating gesture inputs into font characters. A web application, such as a webpage, embedded with the gesture application is served over a network to one or more computing devices for local execution of the gesture input application by a web browsing software on the computing device. The web application includes rules for styling the webpage on the computing device and the source code for the gesture input application. The computing device executing the web application with the web browsing software receives from a user a gesture input and translates the gesture input into at least one standard font character as an input to the web application. In an embodiment, the gesture input application is written in JavaScript source code and executed by a script engine in the web browser on the computing device.

In another embodiment, a network server is disclosed. The server includes a web application module having a web application and a gesture input module having gesture input application. A network interface connected to the server is configured to provide the web application and the gesture input application to a computing device. The computing device include a web browsing application to execute the gesture input application, in order to translate a gesture input into at least one standard font character and provide to the serve an input derived from the at least one standard font character.

In yet another embodiment, a network server includes a web application module embedded with unit-vector-visual feedback application that characterizes a gesture input into a unit vector. The web application is served to a computing device, in order to translate a gesture input into at least one standard font character and provide to the server an input derived from the at least one standard font character. The web application can be further embedded with an animated font character library that is correlated with a private use area of a character encoding method, such as Unicode. This enables the web browsing application to treat the gesture input as standard font characters and to manipulate easily the animated font characters for realistic visual feedback to the user.

### BRIEF DESCRIPTION OF THE FIGURES

FIG. 1 is a block diagram illustrating an example system for serving handwriting character input software embedded in a webpage to a computing device.

FIG. 2 is a block diagram illustrating an computing device that utilizes gestures for controlling the computing device of FIG. 1.

### DESCRIPTION OF THE ILLUSTRATED EMBODIMENTS

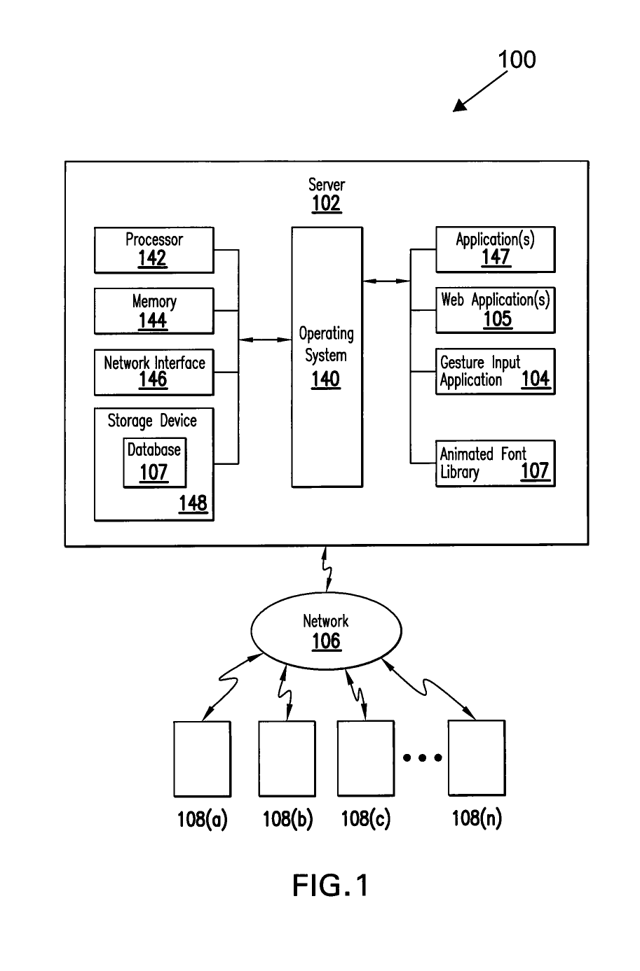

FIG. 1 shows a block diagram of a system 100 for serving a gesture input application 104 to a computing device 108 for local execution on computing device 108 by a web browser 112. Gesture input application 104 can be embedded in a web application 110, such as a webpage 110, and stored in a network server 102. Server 102 transmits web application 110, with the embedded gesture input application 104, to computing device 108 for execution by web browser 112. Web browser 112 analyzes and translates a detected gesture input into standard font character inputs or commands.

In one embodiment, gesture input application 104 includes character recognition software described in U.S. Pat. No. 6,647,145, the contents of which are hereby incorporated by reference herein. The application described in the '145 patent, from hereon after referred to as the unit-vector-visual feedback (“UVVF”) application, relies on the recognition of unit vectors characterizing finger movements to display a perfect font character in step with each finger movement. The UVVF method is a simple efficient application that can be easily embedded into web application 106 for execution by web browser 112.

Gesture input application 104 can further include a visual feedback application, as described in co-pending U.S. patent application Ser. No. ______ titled, Method and System for Providing Animated Font for Character and Command Input to a Computer, filed Aug. 23, 2013, by the same inventors, the contents of which are hereby incorporated by reference herein. Gesture input application 104 can include an animated font character library with component animated font characters and completed animated font characters where component animated font characters are segments of completed animated font characters. These component animated font characters shown on the display resolve into completed animated font characters in step with the gesture input. The animated font characters are correlated, with a private use area of a character encoding method, such as Unicode, therefore these animated font characters are treated by web browser 112 as standard font characters. This enables web browser 112 to manipulate easily the animated font characters for realistic visual feedback. The completed animated font character is then seamlessly exchanged for its corresponding standard font character as an input or action commands to server 102.

Even though the preferred gesture input application 104 in the instant disclosure is the UVVF application, one skilled in the art will recognize that any type of gesture input application 104 can be used, provided such gesture input application 104 can be efficiently served by server 102 to computing device 108 for local execution in web browser 112. One skilled in the art will further recognize, that visual feedback, while advantageous, is not required; and further, any type of visual feedback can be used, for example, animated font characters may be stored as bitmaps or other files in gesture input application 104.

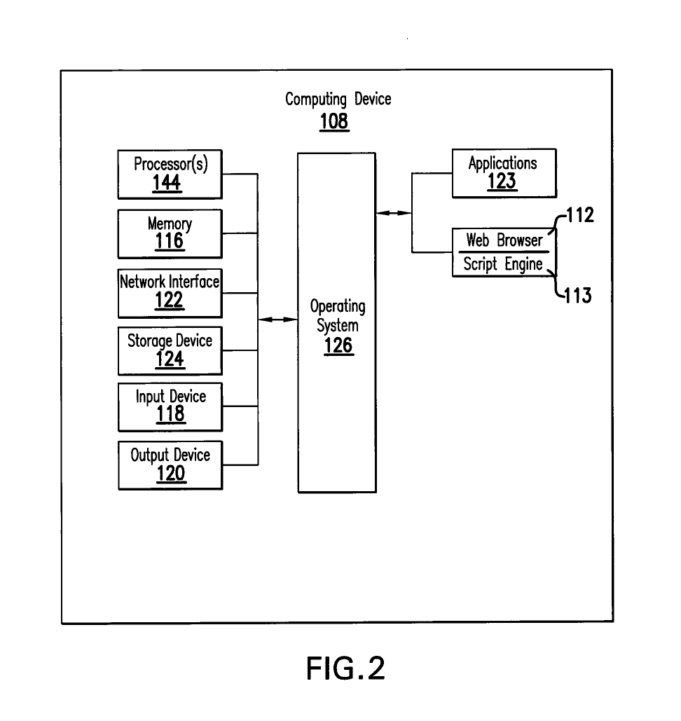

FIG. 2 shows computing device 108, which is more fully described below. Generally, computing device 108 requests and receives a web application 105 from server 102 embed with gesture input application 108. Gesture input application 108 can be embedded within the mark-up language of web application 105, such mark-up language includes XTML or HTML, or embedded in a scripting language file, such as a JavaScript file. A script engine 113 for any other type of rendering engine component that interprets or executes the source code in web application 112) in web browser 112 on computing device 102 executes gesture input application 104 in real-time, in step with the gesture provided to input device 118. This allows the user to input characters or commands in to the webpage as viewed by web browser 112 and served by server 102 by means of simple gestures, with the visual feedback displayed on display 120 of computing device 108. Text input to webpage 105 is affected through the web browser 112 of any touch screen mobile device.

In an embodiment, server 102 serves a webpage 105 to web browser 112 on computing device 108 via a Hypertext Transfer Protocol (HTTP). Web browser 112 on computing device 102 sends a get request:

GET / HTTP/1.1
Host: www.uvvf.com

Server 102 responds with a header:

HTTP/1.1 200 OK
Date: Tue, 19 Oct 2010 14:32:10 GMT
Server: Apache/2.2.11 (Win32) DAV/2
mod_ssl/2.2.11 OpenSSL/0.9.8i PHP/52.9
X-Powered-By: PHP/5.2.9
Content-Length: 2948
Content-Type: text/html

The response of server 102 also includes the following content:

```
<!DOCTYPE HTML>
<html lang=“en-US”>
<head>
    <meta charset=“UTF-8”>
    <title>UVVF</title>
    <link rel=“stylesheet” href=“style.css” />
    <script type=“text/javascript”
src=“uvvf.js”></script>
</head>
<body>
    <h1>UVVF</h1>
    <p>This is a demonstration of UVVF</p>
</body>
</html>
```

There are two files referenced in the head section of the above content. The first file is a style-sheet (named “style.css” above) containing rules for styling webpage 105 and the gesture input area on webpage 105. The second document is a JavaScript file (named “uvvf.js” above) written in JavaScript source code containing gesture input application 108. These two files are downloaded from server 102, by web browser 112 in much the same way as the original HTML file. A third file can be provided containing animated font character library 107 with the digitally encoded images of animated fonts as described in the co-pending application cited above. Animated font character library 107 can be a sprite file, and is referenced by the JavaScript and style-sheet files. Animated font character library 107 is also provided by server 102 in a manner similar to the first two files described above. One skilled in the art would recognize that two or more files identified above can be combined into a single file embedded into webs page 105 and served to web browser 112.

Once all files are loaded into web browser 112, a Document Object Model (DOM) is constructed. Afterwards, gesture input application 108 executes the JavaScript file line-by-line. The JavaScript will initialize webpage 105 to put all necessary component's of gesture input application 108 in place, including an input area and an output area in the form of an animated sprite. The JavaScript is used to detect the gesture and execute the program logic for gesture input application 108 according to the interpreted gesture input, and manipulate the style elements of the DOM to effectively output information to the user. This includes swapping the sprite image position to display the correct animated font and inserting letters into the DOM when a completed character is detected.

In another embodiment, webpage 105 is implemented in a Flash or Java programming language. In this embodiment, gesture input application 104 is embedded into webpage 105 as objects, where web browser 112 allocates a region for the object and passes over responsibility to that region to the appropriate application (Flash/Java) via a plug-in. In this embodiment, when web browser 112 receives a Flash file, it runs the Flash application as a separate process, passing the Flash file to the Flash application, and inserting the Flash application in webpage 105 at the designated location. JavaScript however, does not require a separate application for rendering, rather rendering only requires a JavaScript engine 113 in web browser 112 on computing device 108. The output of the JavaScript engine 113 is simply webpage 105 rather than a designated object within webpage 105.

The methods and process described herein is a system for inputting a hand generated characters into a webpage 103 hosted on a server 102, by way of a computing device 108 running web browser 112. With reference to FIG. 1, server 102 includes any type of network-connected storage device. Server 102 includes web application 105 embed with gesture input application 108, operating system 140, one or more processors 142, memory 144, a network interface 146, and one or more storage devices 148. Operating system 140 and web application 105 embed with gesture input application 108 are executable by one or more components of server 102. The aforementioned components 142, 144, 146, and 148 may be interconnected (physically, communicatively, and/or operatively) for inter-component communications.

Processor 142 is configured to implement functionality and process instructions for execution within server 102. Processors 142, for example, may be capable of processing instructions stored in memory 144 or storage devices 148. Memory 144 stores information within server 102 during operation. Memory 144 can be a computer-readable storage medium or temporary memory, and is used to store program instructions for execution by processors 142. Memory 144, in one example, is used by system software or application software running on server 102 (e.g., operating system 140 and web application 105 embed with gesture input application 108, respectively), to temporarily store information during program execution.

Storage devices 148 can include one or more computer-readable storage media configured to store larger amounts of information than memory 144, including one or more applications 147, web applications 105, gesture input application 104, and animated font character library 107.

Server 102 also includes a network interface 146 to communicate with multiple computing devices 108(a) through 108(n) via one or more networks, e.g., network 106. Network interface 146 may be a network interface card (such as an Ethernet card, an optical transceiver, a radio frequency transceiver, or any other type of device that can send and receive information). Server 102 may include operating system 140, which controls the operation of the components of server 102. Software applications can be included within one or more modules, e.g., web application 105 can be included within its own web application module and gesture input application 108 can be included within its own gesture input module or embedded in the web application module. These applications and/or modules can be implemented or contained within, operable by, executed by, and/or be operatively/communicatively coupled to components of server 102, e.g., processors 142, memory 144, network interface 146, storage devices 148.

With reference to FIG. 2, computing device 108 can be any form of digital computer, including a desktop, laptop, workstation, mobile device, smartphone, tablet, and other similar computing devices. Computing devices 108 includes generally a processor 114, memory 116, an input device, such as a gesture input device 118 or touch-sensitive screen 118, an output device, such as a display 120, it network communication interface 122, and a transceiver, among other components. Computing device 108 may also be provided with a mass storage device 124, such as a micro-drive or other device, to provide additional storage. Each of these components is interconnected using various buses, and several of the components may be mounted on a common motherboard or in other manners as appropriate.

Processor 114 can execute instructions within the computing device 108, including instructions stored in memory 116. Processor 114 may be implemented as a chipset of chips that include separate and multiple analog and digital processors. Processor 114 may provide, for example, for coordination of the other components of computing device 108, such as control of user interfaces (e.g. gesture input device 118), one or more applications 123 run by computing device 108, and wireless communication by computing device 108

Processor 114 may communicate with a user through a control interface, and a display interface coupled to display 120. The display interface may comprise appropriate circuitry for driving display 120 to present graphical and other information to a user. The control interface may receive commands from a user and convert them for submission to the processor.

Processor 114 can utilize any operating system 126 configured to receive instructions via a graphical user interface, such as MICROSOFT WINDOWS, UNIX, and so forth. It is understood that other, light weight operating systems can be used for basic embedded control applications. Processor 114 executes one or more computer programs, such as applications 123 and web browser 112. Generally, operating system 126, applications 123, and web browser 112 are tangibly embodied in a computer-readable medium, e.g. one or more of the fixed and/or removable storage devices 124. Both the operating system 126 and the computer programs may be loaded from such storage devices 124 into memory 116 for execution by processor 114. The computer programs comprise instructions which, when read and executed by the processor, cause the same to perform the steps necessary to execute the steps or features of the present invention; for example, processor 114 executing application software for web browser 112 interprets gesture input application 104 embedded in web application 105 and translates gesture input from input device 118 into standard font characters.

The computing device 108 can include a display panel for output device 120 and input panel for input device 118, where input panel is transparent and overlaid on display panel. The touch-sensitive area is substantially the same size as the active pixels on the display panel. The display panel 111, however, could be any type of display or panel, even including a holographic display, while gesture input device 118 could be a virtual-reality type input where the gesture input is performed in the air or some other medium.

Gesture input application 104 is interpreted by web browser 112. Gesture input application 104 provides instructions for detecting characteristics of gestures, e.g. finger movements, to produce a numerical code for the character as a time dependent sequence of signals, and comparing each characteristic as the character is drawn with a predetermined set of characteristics, so that each signal corresponding to the predetermined characteristic detected at each successive step of movement is displayed on display device 120. In this regard, display device 120 provides visual feedback, wherein a component of a character provided in digital form by server 102 is displayed sequence.

It will be appreciated that other devices, software products, modules and methods could be used to transfer from any web application or webpage 105, gesture input application 104 to computing device 108, allowing the input of finger movements corresponding to intended characters or their associated commands to webpage 105 from computing device 108 running any browser or program of equivalent web-access functionality.

While this disclosure has been particularly shown and described with reference to exemplary embodiments, it should be understood by those of ordinary skill in the art that various changes, substitutions and alterations can be made herein without departing from the scope of the invention as defined by the appended claims and their equivalents.

What is claimed is:

1. A method comprising:
providing on a server a gesture input application adapted for translating gesture input into font characters;
connecting the server to a network having connected thereto at least one computing device; and
embedding the gesture input application into a web application;
serving the web application with an embedded gesture input application to the computing device for locally executing the gesture input application by a web browsing software on the computing device.

2. The method of claim 1, wherein execution on the computing device means the computing device receives gesture input and the computing device translates the gesture input into at least one standard font character.

3. The method of claim 2, and further comprising receiving from the computing device a command derived from the at least one standard font character from the server.

4. The method of claim 3, wherein the web application is a webpage.

5. The method of claim 4, and further comprising receiving a request from the web browsing software on the computing device for the webpage, wherein the web browsing software is adapted for executing the gesture input application.

6. The method of claim 5, wherein the web application includes rules for styling the webpage on the computing device and the gesture input application.

7. The method of claim 6, wherein the gesture input application is executed locally on the computing device without feedback from the server.

8. The method of claim 6, wherein the rules for styling the webpage and the gesture input application comprise JavaScript source code, and further comprising executing the gesture input application with a JavaScript engine of a web browser on the computing device.

9. A network server comprising:
a web application module having a web application;
a gesture input module having gesture input application; and
a network interface, wherein the network interface is configured to provide the web application and the gesture input application to a computing device having a web browsing application for execution of the gesture input application by the web browsing application of the computing device.

10. The network server of claim 9, wherein the computing device is adapted by the gesture input application to translate a gesture input into at least one standard font character and the web browsing application of the computing device provides to the server an input derived from the at least one standard font character.

11. The network server of claim 9, wherein the gesture input application is embedded in the web application when it is provided to the web browsing application of the computing device.

12. The network server of claim 11, wherein the web application includes rules for styling a webpage on the computing device and the gesture input application.

13. The network server of claim 12, wherein the gesture input application is executed locally on the computing device by a script engine in the web browsing application and translates a gesture input into at least one standard font character without feedback from the network server.

14. The network server of claim 12, wherein the web application module further includes an animated font library to provide visual feedback to a user.

15. The network server of claim 9, wherein the web application includes a unit-vector-visual feedback application that characterizes a gesture input into a unit vector.

16. A computing device, comprising:
an input device for receiving a gesture input;
a network interface adapted for connecting to a network; and
a web browsing application adapted for receiving a web application from the network, wherein the web application further including a gesture input application, and wherein the web browsing application is adapted for executing the gesture input application to translate the gesture input into at least one standard font character.

17. The computing device of claim 16, wherein the gesture input application further includes an animated font character library having completed animated font characters and component animated font characters correlated with a private use area of a character encoding method.

18. The computing device of claim 16, wherein the gesture input application includes a unit-vector-visual feedback application that characterizes the gesture input into a unit vector.

19. The computing device of claim 16, wherein the web application includes rules for styling a webpage on the computing device and the gesture input application.

20. The computing device of claim 16, wherein the rules for styling the webpage on the computing device, the gesture input application, and an animated font character library are written in JavaScript, wherein the web browsing application further comprises a script engine to translate the gesture input application and adapt the computing device to translate the gesture input into the least one standard font character as an input to the web browsing application, and wherein the script engine uses the animated font character library to provide visual feedback for the gesture input.
